(19) United States
(12) Patent Application Publication
(10) Pub. No.: US 2016/0023604 A1
(43) Pub. Date: Jan. 28, 2016

(54) Head-Up Display Controller

(71) Applicant: LightSpeed Automotive Technology, Everett, WA (US)

(72) Inventor: Barton James Jenson, Everett, WA (US)

(73) Assignee: LightSpeed Automotive Technology, Everett, WA (US)

(21) Appl. No.: 14/326,376

(22) Filed: Jul. 8, 2014

Related U.S. Application Data
(60) Provisional application No. 61/843,840, filed on Jul. 8, 2013.

(51) Int. Cl. B60R 1/00; G06F 3/0484; G02B 27/01; G06F 3/0488

(52) U.S. Cl. CPC B60R 1/001; G06F 3/0488; G06F 3/04845; G02B 27/0101; G02B 2027/014; G02B 2027/0141; B60R 2300/205

(57) ABSTRACT

The instant application discloses, among other things, techniques to allow information from multiple devices to be displayed on a Head-Up Display, allowing a user to focus on safety while being distracted minimally, but still benefiting from having the multiple devices. Head-Up Display Controller may also display only important information, and use simple-to-understand symbology, which may allow a user to quickly and easily see and understand information on the Head-Up Display.

### FIELD

This disclosure relates to Head-Up Display Controller.

### BACKGROUND

More and more electronic devices are finding their way into use while their users are driving or operating equipment. Mobile phones, GPSs, business communication radios, entertainment systems, vehicle monitoring systems, portable computers, and other electronics draw a driver's attention from what's ahead or around them to each of the displays involved.

These distractions are responsible for many accidents for cars, trucks, and heavy equipment.

### SUMMARY

The instant application discloses, among other things, techniques to allow information from multiple devices to be displayed on a Head-Up Display (HUD), allowing a user to focus on safety, or important tasks, while being minimally distracted, but still benefiting from having the multiple devices. While using a Head-Up Display may help reduce distractions, Head-Up Display Controller may also display only important information, and use simple-to-understand symbology, which may allow a user to quickly and easily see and understand information on the Head-Up Display.

A head-up display may be a display configured to present visual information along the line of sight of a user. For example, a head-up display used in a car may allow a driver to continue looking through a windshield while seeing visual information displayed in the driver's field of vision.

### BRIEF DESCRIPTION OF THE DRAWINGS

FIG. 1 is a system diagram of an embodiment of Head-Up Display Controller.

FIG. 2 illustrates data flows between a Device 2-1, such as a smart phone, laptop, or tablet computer and Head-Up Display Controller.

FIG. 3 is an example of a touch-based menu, according to one embodiment.

FIGS. 4-7 illustrate a menu navigation flow chart example.

FIG. 8 illustrates a flow chart for Head-Up Display Controller, according to one embodiment.

FIG. 9 is a system diagram of one embodiment of a Head-Up Display Controller.

FIG. 10 illustrates a component diagram of a computing device according to one embodiment.

### DETAILED DESCRIPTION

Head-Up Display Controller may intelligently combine data and control functions from multiple devices into a single head-up display with simplified symbology, allowing a user to focus on other tasks, while still benefiting from the functionality of the multiple devices. Control of the multiple devices may be accomplished using blind user interface techniques, for example voice recognition, gestures, or simple touch commands.

Head-Up Display Controller may limit the amount of information displayed at a time, which may prevent a user from becoming overwhelmed with data. For example, HUD Controller may show speed and engine RPM information. An alert may override display content, for example, a low oil pressure condition may be displayed with a priority over engine RPM information. Priority determinations may be set by default or may be configured by users. They may be based upon safety or human factor conditions, or upon convenience considerations. For example, an incoming call may cause caller ID information to replace engine RPMs on a display. A safety-related or urgent alert may take priority over a convenience alert. For example, if a piece of equipment is moving dangerously close to a parked vehicle, an alert notifying the operator of the situation may take priority over displaying engine RPM.

When the phone call is accepted, or rejected, RPMs may be allowed to reappear on the display. In another example, if the user wants to access a music playlist, the HUD Controller may eliminate all display content and display only a music playlist. More sophisticated algorithms may be implemented to regulate the content that is displayed based factors such as:

a) how critical the information is;

b) how much attention will be required of the vehicle operator to process the information;

c) whether or not the user is requesting the information;

d) whether or not the vehicle operator will need to input additional data, or navigate through menu options; and

e) how complex the symbology is for each item displayed.

One having skill in the art will recognize that other factors may also be considered in prioritizing display output.

A more particular description of certain embodiments of Head-Up Display Controller may be had by references to the embodiments shown in the drawings that form a part of this specification, in which like numerals represent like objects.

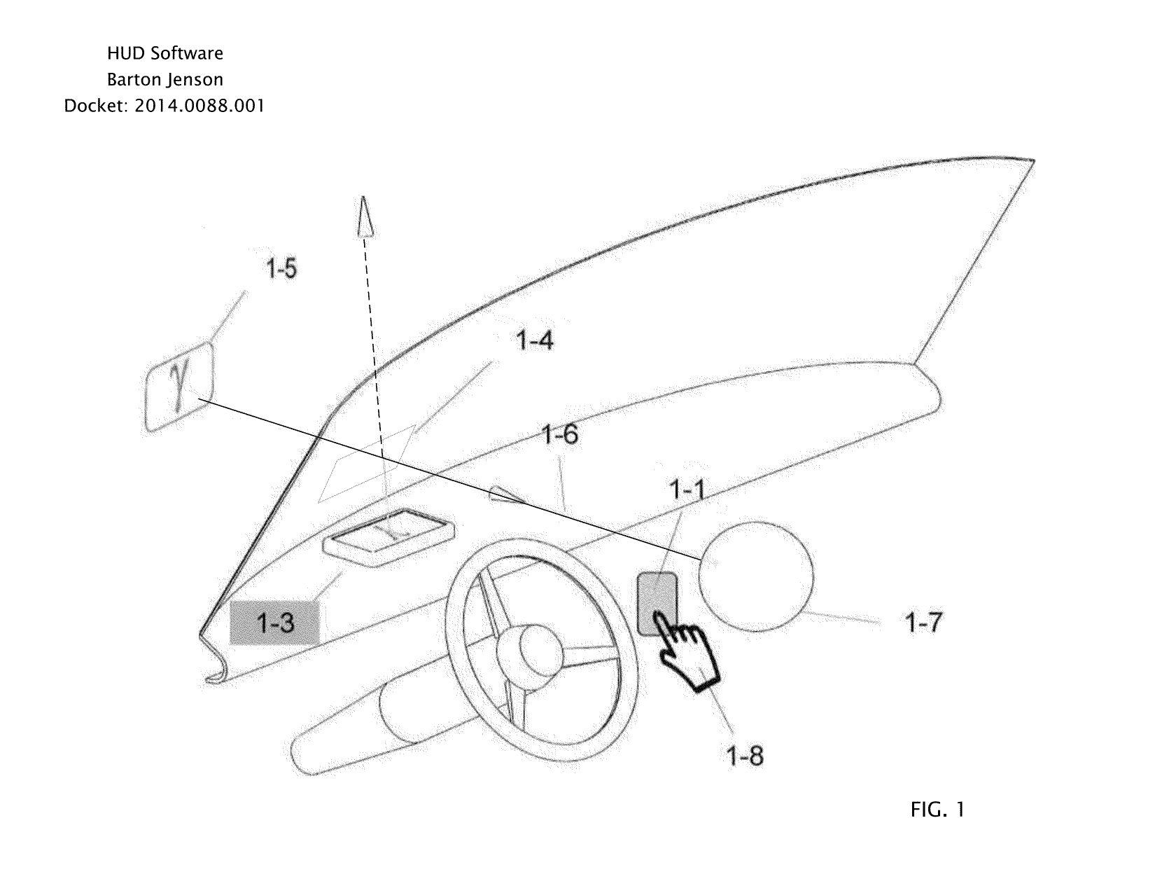

FIG. 1 illustrates a use of a Head-Up Display Controller, according to one embodiment. In this embodiment, a head-up display (HUD) may be configured to operate in tandem with a mobile device, such as a smartphone or laptop computer, with output from the mobile device displayed on the HUD.

In this example, a smart phone (1-1) may be connected via cable or wirelessly, to a HUD projection unit (1-3), which may project display imagery onto an optical combiner (1-4) within an automobile. The optical combiner may be positioned to superimpose display imagery (1-5) onto the vehicle operator's line-of-sight (1-6). The vehicle operator's head (1-7) may be positioned in a normal manner to allow a view of the road through the combiner while operating the vehicle. The vehicle operator may use simple touch commands to navigate through menu options or control display content, using digits on the hand (1-8), without removing their eyes from the display or road. This may be considered a blind-touch user interface. A blind-touch (or blind user interface) may be an interface that does not rely on sight to control or receive information from a piece of equipment or device. For example, voice input, gestures, touch inputs, finger movements, or head movements may be forms of blind user interfaces. The touchpad on a laptop or touch-screen on a tablet computer may be used if the laptop or tablet computer are utilized and configured to control HUD content.

The application of this system may extend to any vehicle platform beyond the automobile, including but not limited to haul trucks, dump trucks, tractors, combines, cranes, trains, airplanes, boats, and spacecraft. In any of these vehicle platforms, data from gages, instruments, warning systems, a dispatch center or other sources may be important to display on a HUD without causing the vehicle operator to divert their eyes from an important task. The performance of the task may be enhanced by allowing the vehicle operator to keep their eyes on a critical part of the task. The controlling of other devices and accessing of information important in the performance of that task may improve efficiency if the vehicle operator sees that information overlaid on a natural scene.

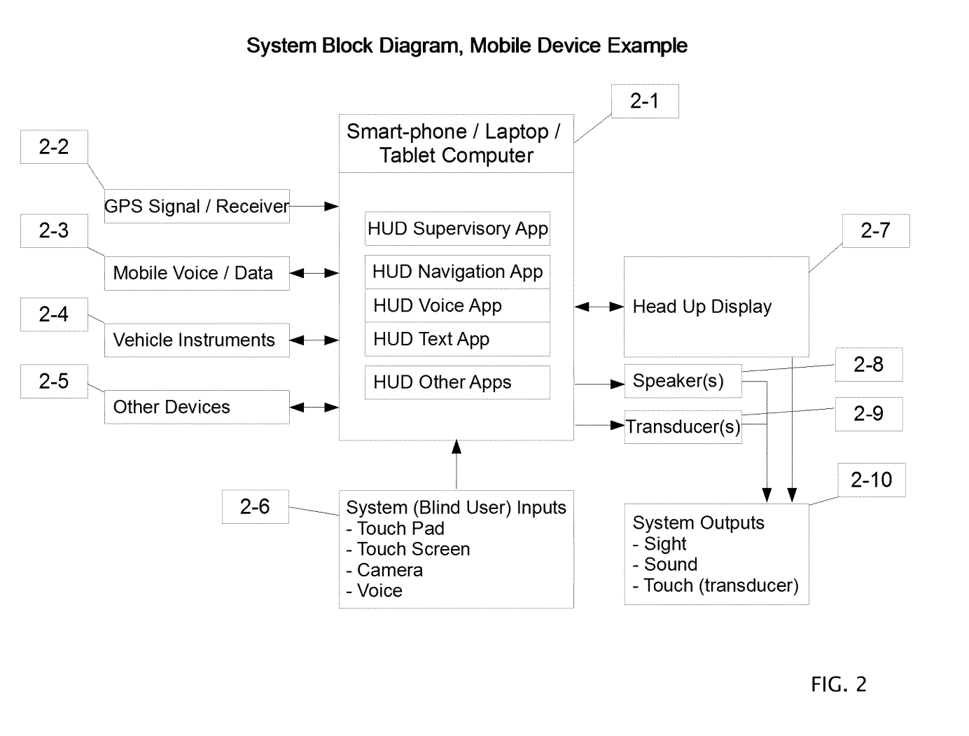

FIG. 2 illustrates data flows between a Device 2-1, such as a smart phone, laptop, or tablet computer and Head-Up Display Controller. Device 2-1 may include sources of information such as a GPS receiver (2-2), mobile voice/data service (2-3), vehicle instruments (2-4) or other devices (2-5). Connection to these other devices or sources of information may be hard wired or through wireless connections such as Blue Tooth, or WiFi (IEEE 802.11), or other means of communication. The system may have the ability to receive blind user inputs (2-6); that is, user inputs that allow efficient access without direct visual contact. This may be done a variety of ways using components on the mobile device such as the device's touch-screen, camera or microphone. System outputs may consist of a HUD image (2-7), speaker sound output (2-8), transducer outputs (2-9) that may vibrate or other system outputs (2-10) that generally do not require operator sight. Transducers may be located in a driver's seat or on specific control devices within the vehicle in order to alert the driver about certain conditions or information by vibrations, taps, or patterns of vibrations and taps.

Dedicated user interface devices may be connected to the mobile device, either hard-wired or wirelessly. For example, a dedicated touch pad that is located in a convenient location for a vehicle operator to access may enable greater efficiency of the vehicle operator interacting with multiple devices simultaneously. A dedicated touch pad may also be designed to integrate with a steering wheel, vehicle control, dashboard, or other part of a vehicle, which may not be easily done with a larger mobile device such as a laptop. This may allow the vehicle operator to keep their hands on or near the primary vehicle controls.

The system may receive blind user inputs through the user interface, which may be simple touch-based inputs as shown in Table 1 below. The user interface and HUD system may be specifically designed to not require the vehicle or equipment operator to look at the user interface, unlike a keypad on a cell phone.

For example, a cell phone key pad that is strictly touch-based may require the user to look and see where each number is that they desire to press. A blind touch-screen user interface may merely require that the user feel where the touch screen is and make simple strokes, symbols, or combination thereof. A very rich command set can be developed this way. The touch screen may be programmed to be blank during use, in which case the user may have no reason to look at the touch screen and is encouraged to look at the HUD image, which may be disposed in a desirable viewing position.

TABLE 1
Example User Interface Command Set

| Touch Input | HUD Action | HUD Output |
|---|---|---|
| Upward stroke | Scroll up (alternate | Next item in list is |
| | down) through list of | highlighted or centered |
| | menu options or items | in display |
| Downward | Scroll down (alternate | Previous item in list is |
| stroke | up) through list of menu | highlighted or centered |
| | options or items | in display |
| Right stroke | Menu item select; enter | Sub-menu is displayed |
| | sub-menu for item | |
| | currently selected | |
| Left stroke | Menu item de-select; | Sub-menu is removed |
| | exit sub-menu for item | from display and higher |
| | currently selected | level menu is displayed |
| Clockwise | Scroll forward or down | Next item in list is |
| stroke | through list of menu | highlighted or centered |
| | options or items | in display |
| Counter- | Scroll backwards or up | Previous item in list is |
| clockwise | through list of menu | highlighted or centered |
| stroke | options or items | in display |
| Single tap | Menu item select; enter | Sub-menu is displayed, |
| | sub-menu for item | or appropriate display |
| | currently selected. Or, | symbology for action. |
| | execute action if item | |
| | does not have sub- | |
| | menu. Or, wake device | |
| | and bring up menu for | |
| | current application | |
| Double tap | Execute action. Or, if | Appropriate display |
| | sub-menu applies, then | symbology for action |
| | execute default action | |
| | for menu item selected | |
| Special stroke/set | Short cut to specific | Appropriate display |
| of strokes in | menu item or action | symbology for menu |
| succession | | item or action. |
| Two fingers | Zoom in | Zoom in on selected |
| spreading apart | | area on display |
| Two fingers moving | Zoom out | Zoom out on display |
| closer together | | |

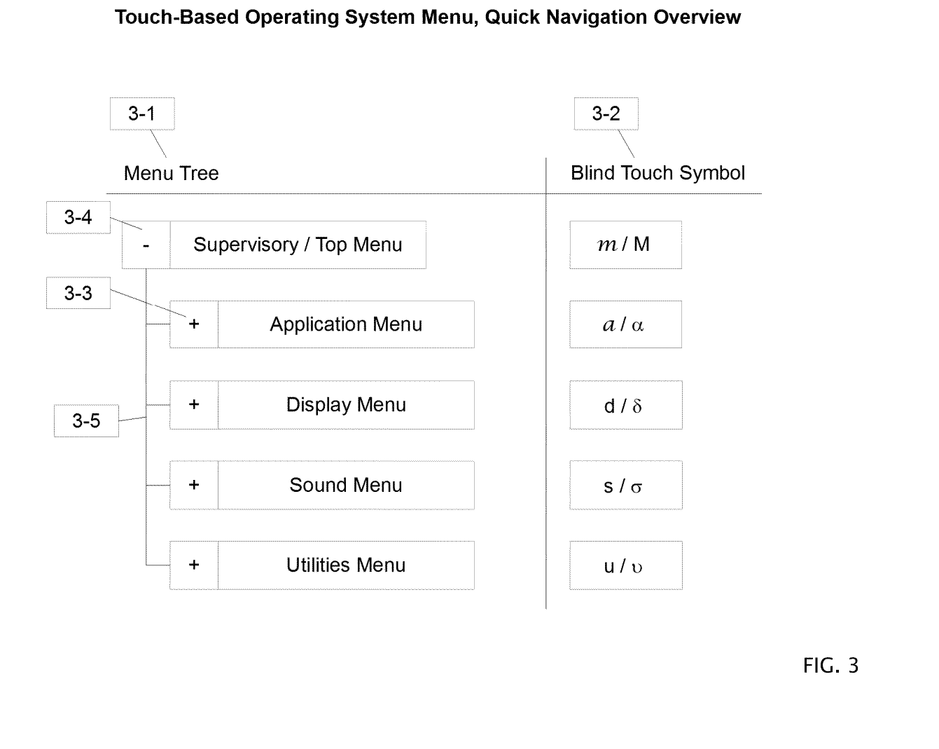

FIG. 3 is an example of a touch-based menu for quick navigation, according to one embodiment. Quick navigation through menu options may be possible with special strokes as shown in FIG. 3. Various menu options are shown in the left hand column (3-1) in a hierarchical schema as depicted with the “+” sign and“−” signs. For example, the“+” sign (3-3) on the application menu may denote additional menu options or functions are available. The “−” sign (3-4) may denote that all sub-menu options or functions subsidiary to the application menu are shown by the line connecting the box with the minus sign (3-5) to other boxes containing“+” signs. Navigating in and out of different menu options, or software applications, may be possible with blind touch symbols (3-2), or simple and special strokes as shown in the right hand column. These blind touch symbols may enable shortcuts to specific menu options or applications. These special strokes may be simple symbols or letters that do not require the operator to look at the touch screen. In this way, the system may provide a blind user interface with quick navigation.

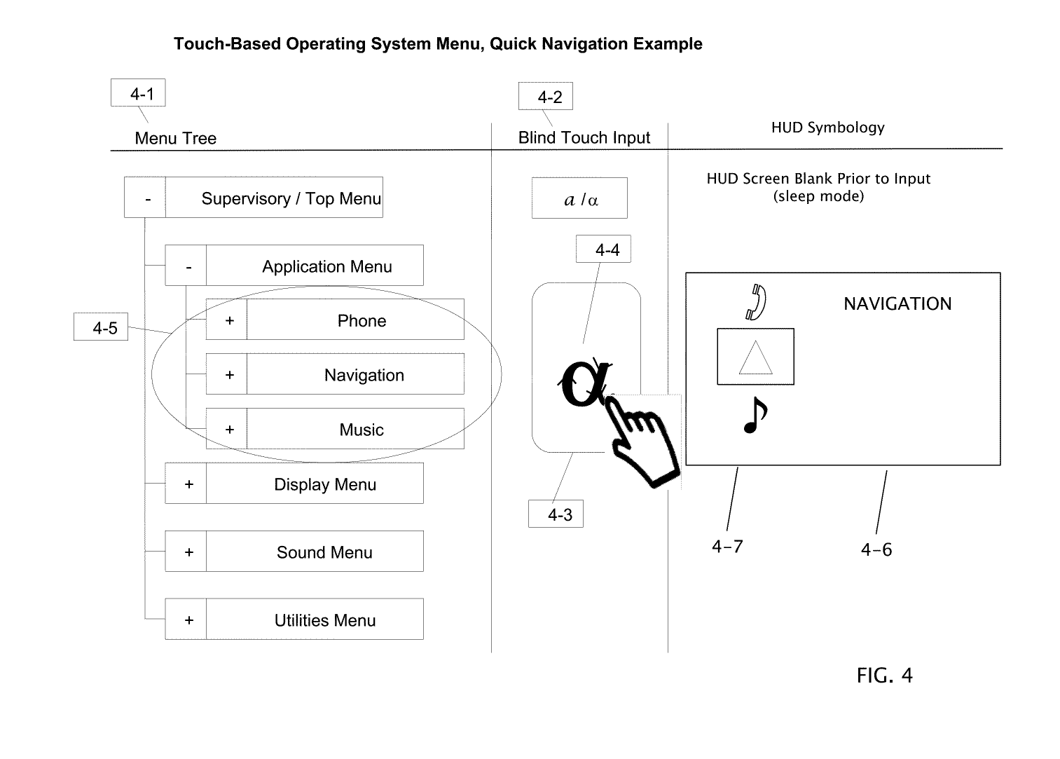

FIGS. 4-7 illustrate a menu navigation flow chart example. A sequence of four user inputs is shown from FIG. 4 to FIG. 7. A hierarchical menu tree is shown in the left hand column of the flow chart (4-1). Blind touch input is shown in the middle column (4-2). A smart-phone is shown (4-3) as the input device, however a touch pad on a laptop, a touch screen on a tablet computer, or a dedicated touch pad are other examples of potential input devices. The example menu navigation may begin with the system in a neutral, or sleep state in which there is no display output. The system may also be in any another state of operation with the HUD image displaying content appropriate to that state.

The user may input a Greek letter alpha (4-4) on the touch interface, which may immediately take the system to the applications menu (4-5). In this example, Navigation is the default application, which is shown on the HUD image (4-6). The HUD image may show all applications available to the user (4-7).

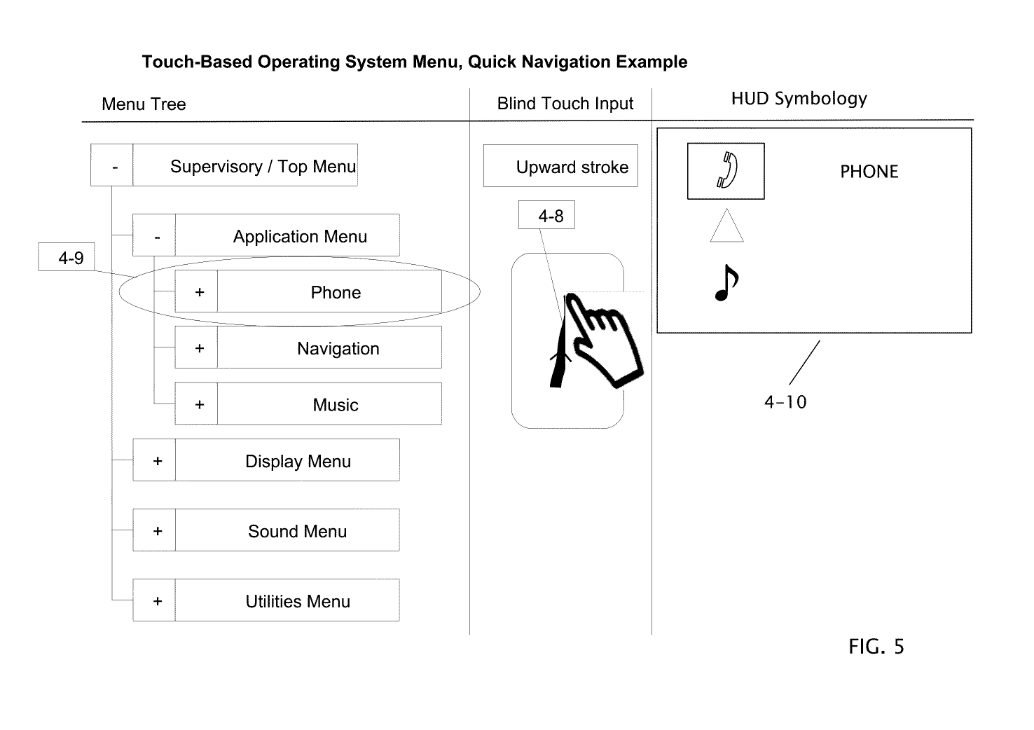

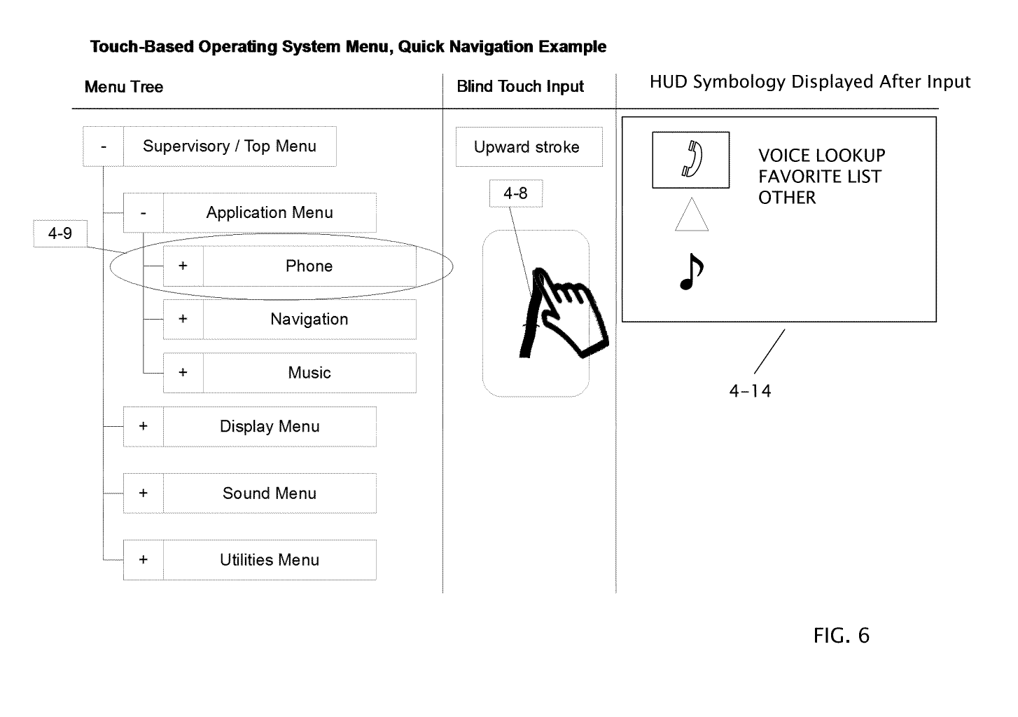

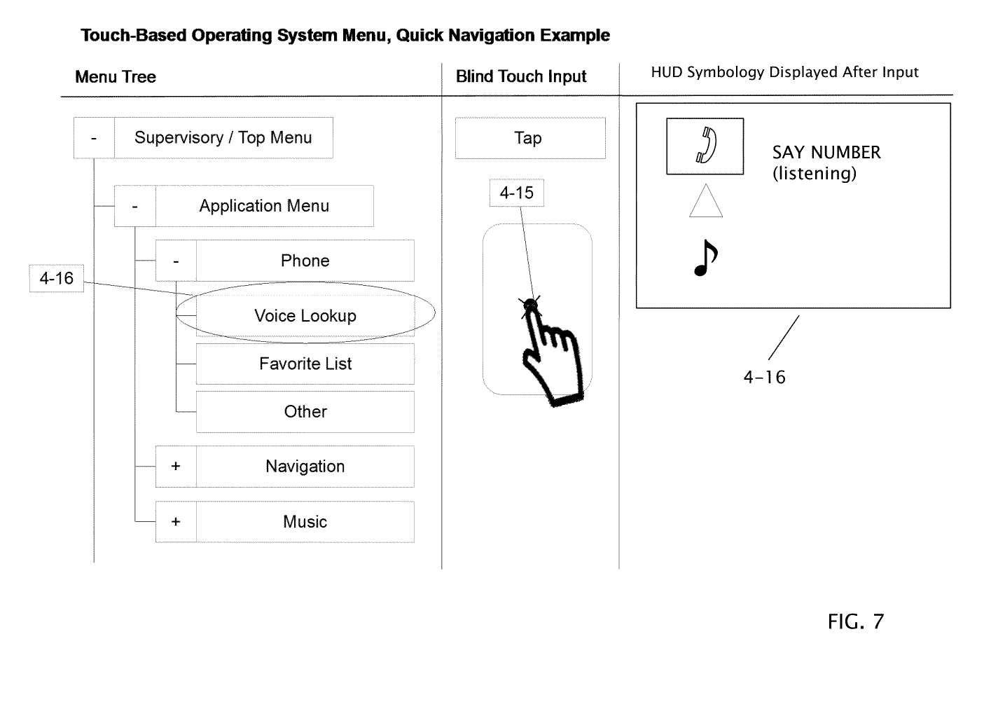

On FIG. 5, an upward stroke (4-8) may take the system to the phone application (4-9), which may be displayed in the HUD image (4-10). FIG. 6 then shows that a right stroke (4-12) may take the system to the phone application menu (4-13), which may be displayed in the HUD image (4-14). FIG. 7 shows that from there, a tap (4-15) on the voice input menu option within the phone application (4-16) may execute a command for the system to receive voice phone number input as shown in the HUD image (4-17). None of the user touch inputs may require the operator to look at the touch screen.

Feedback that the user is navigating through the menu options may be in the HUD display output, which may encourage or require the vehicle or equipment operator to keep their eyes pointed in a desirable direction.

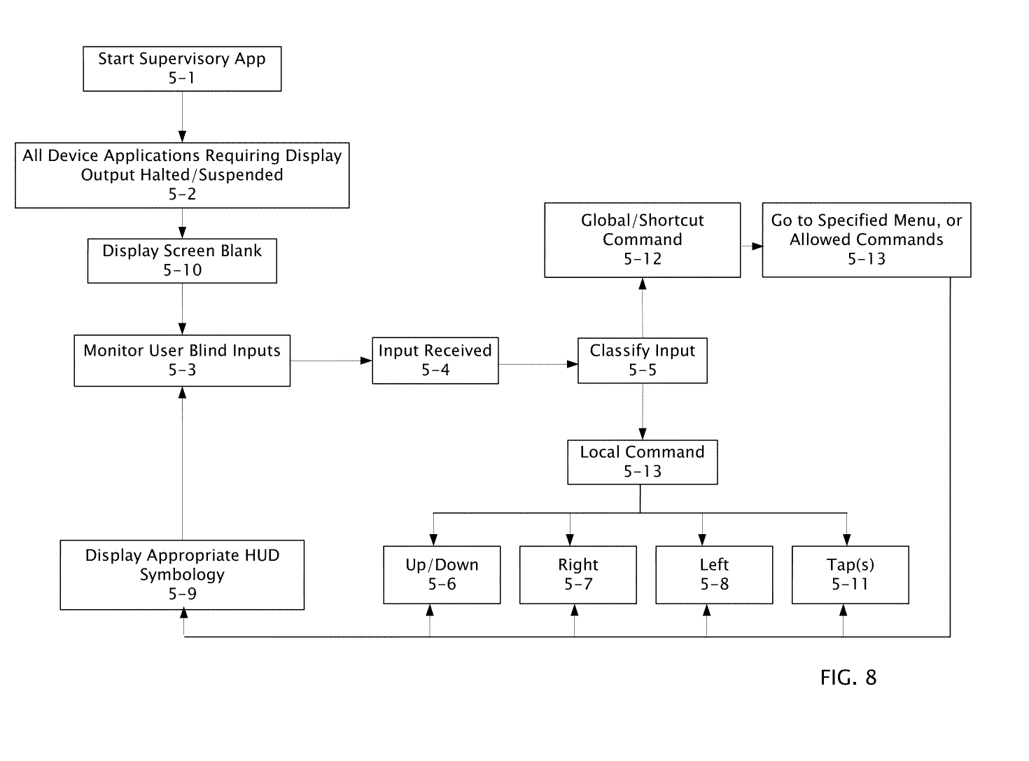

FIG. 8 illustrates a flow chart for Head-Up Display Controller, according to one embodiment. The Head-Up Display Controller may manage the control of all devices and subsequent display of information on the HUD. Once the application is started (5-1), all device applications that require display or other output may be halted or suspended (5-2). This may be done in order to carefully direct only critical display content to the HUD, which may be positioned to keep the vehicle or equipment operator's eyes on the road or job. In order to encourage the operator to keep their eyes on the road or job, the application may render the mobile device's screen blank (5-10). The blind user input (5-3) may be enabled and may continuously monitor user inputs. Once an input is received, (5-4) it may be classified (5-5) according to whether it is a global (5-12) or local (5-13) command.

Global commands may allow the user to navigate quickly, via shortcuts, to specific applications, menu options or functions within the systems suite of applications. Local commands may allow the user to navigate amongst menu options and application functions locally, or at the current state of the system's operation. Four example simple user local inputs are shown; the up/down stroke (5-6), which may increment the menu option to the next or prior item in the list, the right stroke (5-7), which may cause the software to enter a sub-menu for a currently selected menu item, the left stroke (5-8), which may cause the software to exit the current sub-menu item and go to a parent menu list, and combination of taps (5-11), which may select an item from a menu list, or execute a command or function for the currently selected item if allowed. The global/Shortcut Command (5-12) may be a special symbol that may take the system directly to a desired application, menu or allowed commands (5-13). After a blind user input is processed, including the navigation of software to the appropriate menu selection of command, appropriate HUD display symbology (5-9) may be made viewable to the user.

The blind user inputs may be generalized to any input that does not require the vehicle or equipment operator to significantly divert their visual attention or cognitive attention from an important task. This may include inputs from a touch pad on laptop computer, or voice input to a microphone, or video input through a camera or vision system. A separate, dedicated blind input device may be used in combination with a smart-phone, or laptop, or tablet computer, or any device with a computer processor, whereby software may not be located on the dedicated blind input device, but rather on the device with the computer processor. It may not be necessary to view either that input device or the device with the computer processor and HUD system application software.

Outputs from the system may also be generalized to include audio output, or touch output such as vibrating transducers, to augment the HUD image output and further encourage the operator to keep their eyes on the road or job in the event the job requires them to look briefly away from the HUD display output.

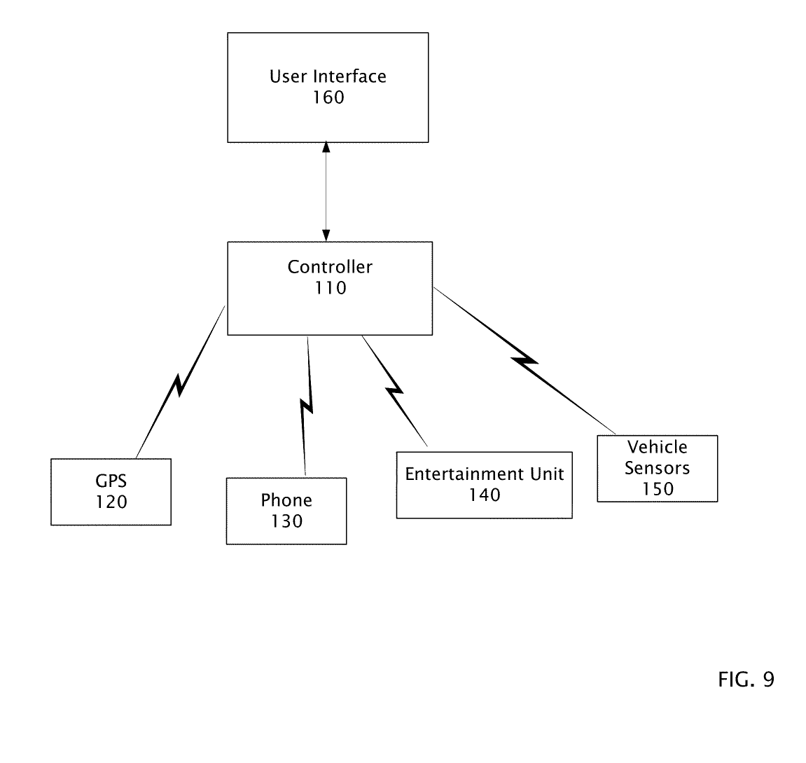

FIG. 9 is a system diagram of one embodiment of a Head-Up Display Controller. The system may comprise Controller 110, which may execute Head-Up Display Controller, and various attached devices, such as GPS Unit 120, Phone 130, Entertainment Unit 140, and Vehicle Sensors 150. Controller 110 may be a smartphone, a laptop or tablet computer, or may be a device designed and configured to execute Head-Up Display Controller.

Controller 110 may be coupled to each attached device by wire, a wired bus, Wi-Fi, cellular data access methods, such as 3G or 4GLTE, Near Field Communications (NFC), Bluetooth, the internet, local area networks, wide area networks, or any combination of these or other means of providing data transfer capabilities. Other devices may also be attached to Controller 110.

User Interface 160 may include a Head-Up Display, and may include other means of communicating with a user, such as audio output or tactile output, including vibration. One having skill in the art will recognize that other forms of user interface may be used in various applications.

User Interface 160 may also include one or more means of receiving inputs. For example, User Interface 160 may include a touch screen, speech recognition, a keyboard, a mouse, a joystick, or other means for accepting inputs from a user. One having skill in the art will recognize that various forms of input may be acceptable for controlling attached devices.

Controller 110 may, for example, communicate with Phone 130 via Bluetooth, and may allow a user to place or receive phone calls, and may, for example, display a caller ID phone number on a Head-Up display upon receiving a call, allowing the user to answer or ignore the call with a touch on the Head-Up display. A phone book may be displayed and may allow a user to select a number to call by a touch screen interface on a Head-Up display. Controller 110 may then send appropriate commands to Phone 130 to initiate a call.

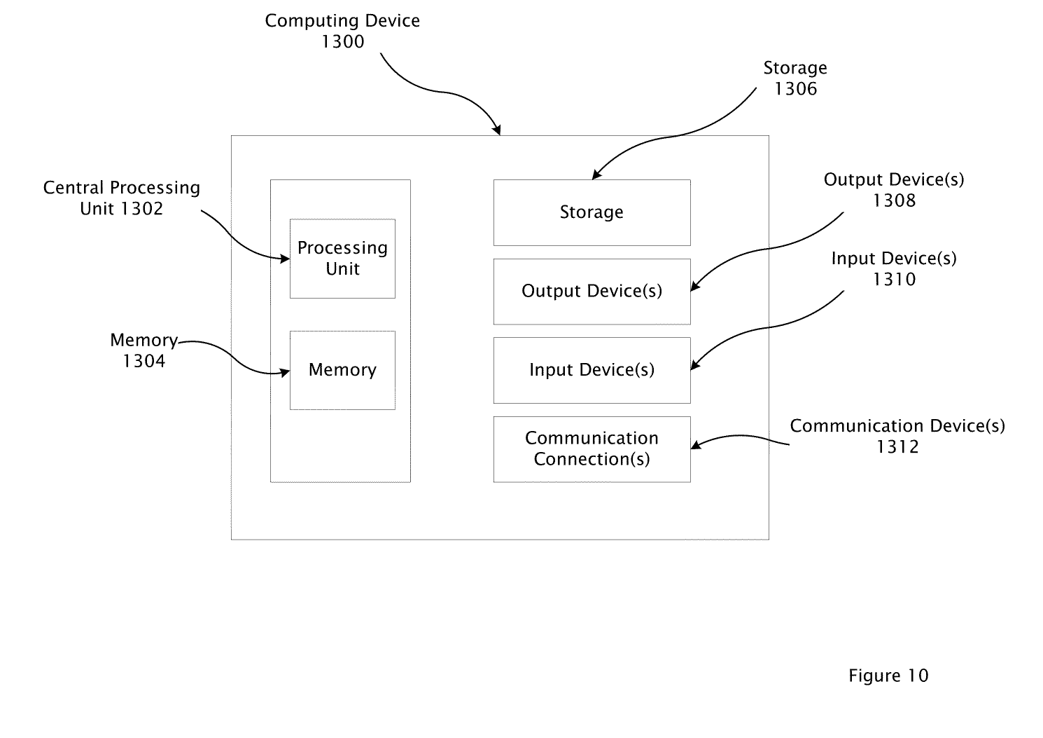

FIG. 10 illustrates a component diagram of a computing device according to one embodiment. The Computing Device (1300) can be utilized to implement one or more computing devices, computer processes, or software modules described herein, including, for example, but not limited to Controller 110. In one example, the Computing Device (1300) can be utilized to process calculations, execute instructions, receive and transmit digital signals. In another example, the Computing Device (1300) can be utilized to process calculations, execute instructions, receive and transmit digital signals, receive and transmit search queries, and hypertext, compile computer code as required by Controller 110. The Computing Device (1300) can be any general or special purpose computer now known or to become known capable of performing the steps and/or performing the functions described herein, either in software, hardware, firmware, or a combination thereof.

In its most basic configuration, Computing Device (1300) typically includes at least one Central Processing Unit (CPU) (1302) and Memory (1304). Depending on the exact configuration and type of Computing Device (1300), Memory (1304) may be volatile (such as RAM), non-volatile (such as ROM, flash memory, etc.) or some combination of the two. Additionally, Computing Device (1300) may also have additional features/functionality. For example, Computing Device (1300) may include multiple CPU's. The described methods may be executed in any manner by any processing unit in computing device (1300). For example, the described process may be executed by both multiple CPU's in parallel.

Computing Device (1300) may also include additional storage (removable and/or non-removable) including, but not limited to, magnetic or optical disks or tape. Such additional storage is illustrated in FIG. 5 by Storage (1306). Computer readable storage media includes volatile and nonvolatile, removable and non-removable media implemented in any method or technology for storage of information such as computer readable instructions, data structures, program modules or other data. Memory (1304) and Storage (1306) are all examples of computer storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can store the desired information and which can accessed by computing device (1300). Any such computer readable storage media may be part of computing device (1300). Computer readable storage media does not include transient signals.

Computing Device (1300) may also contain Communications Device(s) (1312) that allow the device to communicate with other devices. Communications Device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer storage media and communication media. The described methods may be encoded in any computer-readable media in any form, such as data, computer-executable instructions, and the like.

Computing Device (1300) may also have Input Device(s) (1310) such as keyboard, mouse, pen, voice input device, touch input device, etc. Output Device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples and data provide a complete description of the manufacture and use of the invention. Since many embodiments of the invention can be made without departing from the spirit and scope of the invention, the invention resides in the claims hereinafter appended.

1. A vehicular interface system, comprising:
a head-up display adapted to present visual information in a line-of-sight of operator of a vehicle;
an input device adapted to receive input from the operator; and
software running on a controller, configured to adjust the visual information presented by the heads-up display in response to the input received by the input device.

2. The system of claim 1, further comprising a device coupled to the controller, configured to output display information to the controller, and receive instructions from the controller.

3. The system of claim 2, wherein the device is selected from a group consisting of a smartphone, a GPS, a vehicle sensor, an entertainment unit, a laptop, and a tablet.

4. The system of claim 1 wherein the controller limits the displayed information to highly relevant items for a current context.

5. The system of claim 1, further comprising adjusting the visual information in response to an alert.

6. The system of claim 1, wherein the visual information presented by the heads-up display uses a symbology selected to reduce the workload of a user for understanding the information.

7. The system of claim 1, wherein the touch input device is configured to promote blind touching.

8. A method, comprising:
sending a request for information to a device;
receiving the requested information from the device;
determining relevant high priority information from the received information; and
displaying the high priority information on a head-up display.

9. The method of claim 8, wherein the determining relevant high priority information comprises selecting at most three items of information.

10. The method of claim 8 wherein the device is selected from a group consisting of a smartphone, a GPS, a vehicle sensor, an entertainment unit, a laptop, and a tablet.

11. The method of claim 8, wherein the determining relevant high priority information comprises determining if the information relates to a safety issue.

12. The method of claim 8, wherein the determining relevant high priority information comprises determining if the information is urgent.
